(19) United States
(12) Patent Application Publication
(10) Pub. No.: US 2004/0010972 A1
(43) Pub. Date: Jan. 22, 2004

(54) Fully prefabricated steel armored blind

(76) Inventor: Gualtiero Crozzoli, Rome (IT)

Correspondence Address: HOWARD & HOWARD ATTORNEYS, P.C., The Pinehurst Office Center, Suite 101, 39400 Woodward Avenue, Bloomfield Hills, MI, 48304-5151, US

(21) Appl. No.: 10/418,432

(22) Filed: Apr. 17, 2003

(30) Foreign Application Priority Data
Apr. 17, 2002 (IT) 2002A000214

(51) Int. Cl. E05B 65/04

(52) U.S. Cl. 49/67; 49/63; 49/61

(57) ABSTRACT

The subject invention is directed toward a blind assembly having a pair of vertical elements. The vertical elements each have a top and bottom and a plurality of slots formed therein. An upper transverse element engages the tops of the vertical elements and a lower transverse element similarly engages the bottoms of the vertical elements. A plurality of slabs engage the slots of the vertical elements and extend substantially parallel with the upper and lower transverse elements. A mounting arrangement interlocks the upper transverse element to the tops of the vertical elements, the lower transverse element to the bottoms of the vertical elements, and the slabs to the vertical elements for eliminating the need to weld the blind assembly.

### RELATED APPLICATION

The subject patent application claims priority to and the benefits of co-pending Italian Patent Application, serial no. 2002A000214, which was filed on Apr. 17, 2002.

### PRIOR ART

Referring to FIGS. 1-3, currently steel blinds are realized employing some commercial profiles (AA) already provided with slots, because of the slats introduction (see FIG. 1) such blinds are cut, assembled and welded to be then finished with lapping machines. The profile has particular features, that is the upper part of the wings post is cut at 45°, while in the bottom part it is cut at 90° (see FIG. 2).

During the last twenty years the above system has not been changed, because it had been reached an optimum compromise between the need of employing fixed pitch slotted elements and the ideal solution providing the use of the variable terminal, the latter (that is still used), when used in the bottom part of the casing, completing the gap (D) in the use of the slots useful in the wing post and the real measure necessary to have a blind with the measures of the counterframe. Said solution was positively introduced by the applicant with the patent no. 0218144 that is actually of public domain.

However, the above solution provided the assembling by weldings and following grindings (in other words, they are two “C” shaped profiles, slidable each other to conform with the profile (A) to the last usable slot (U) and with the profile (B) to the base end. All the basic industry has maintained fixed and as a strong point the fixed pitch slot without being able to depart from the wing's welding. This is valid both in the upper part, coupled at 45°, and in the bottom part coupled at 90° to the variable terminal.

The system providing the use of anchorage square elements for the steel has been a failure for the same steel, since this method has been derived from the constructing system for aluminum casings. This was evident for the colossal difference existing between the wellgauged extrusion products (aluminum) and the low precision profiled product (steel), the latter being also characterized by infinite size variations, even in the section of the same lot. Thus, the square element fitting followed the profile imperfections creating some minimal gaps and clearances, not compatible with a skilful structure.

The object of the inventor is allowing to the steel blind manufacturers to realize them with perfectly skilful structures, without welding some profiles and leaving the galvanizing film intact in the contact points; and further reducing the execution times even of the 80%.

### SUMMARY OF INVENTION

The system “Advanced Siver” realizes all the above having joined the wing coupling system with the thoughness required by the user. By this innovation it is wished to create a metallurgical and mechanical company supplying to the national and foreign market the prefabricated product as a kit ready to be assembled by the client, not raw but already painted, because the “Advanced Siver” system does not damage the preliminary painting in the final assembling phase.

The blind is comprised of five profiles by which it is possible to realize every kind of blinds that could be required on the market, two of said profiles carrying out the function of a chassis, and the three others are employed for the wings.

A basic characteristic is that the wings are rigorously cut and assembled at 90°, using particular arrangements of absolute toughness; so it is possible to be sure to realize an effective armor plating without employing too expensive structures, deriving from profiles welded and then ground, adjusted, etc.

All the accessories are assembled with as much care and attention to the market request; that is absolute inaccessibility to the forcing attempts. The measures of the wing's height cut have a fixed pitch corresponding to the slot pitch, the other variations with respect to the real measure of the light gap are compensated in the upper traverse employing the adjustable butterfly support.

It is believed that this study could be the subject matter of an industrial invention patent, solving all the innumerable problems that had prevented their realization till now, also modifying the profiles, the accessories and the working mode.

In particular, the subject invention is directed toward a blind assembly comprising a pair of vertical elements each having a top and bottom and a plurality of slots formed therein. An upper transverse element engages the tops of the vertical elements. A lower transverse element similarly engages the bottoms of the vertical elements. A plurality of slabs engage the slots of the vertical elements and extend substantially parallel with the upper and lower transverse elements. A mounting arrangement interlocks the upper transverse element to the tops of the vertical elements, the lower transverse element to the bottoms of the vertical elements, and the slabs to the vertical elements for eliminating the need to weld the blind assembly.

### DESCRIPTION OF THE DRAWINGS

Other advantages of the present invention will be readily appreciated as the same becomes better understood by reference to the following detailed description when considered in connection with the accompanying drawings wherein:

FIG. 1 is a interior view of a vertical support element of the prior art;

FIG. 2 is a fragmented side view of the vertical support element of the prior art;

FIG. 3 is a fragmented interior view of the vertical support element of the prior art;

FIG. 4 is a perspective view of a blind assembly in accordance with the subject invention;

FIG. 5 is a perspective view of an alternative embodiment of the blind assembly;

FIG. 6 is an exploded perspective view of a frame in accordance with the subject invention;

FIG. 7 is a fragmented side view of a portion of the frame;

FIG. 8 is a fragmented perspective view of the frame having a hinge disposed therein;

FIG. 9 is a side view of the frame and hinge of FIG. 6;

FIG. 10 is a perspective view of a partially assembled blind assembly in accordance with the subject invention having a pair of vertical elements and three transverse elements;

FIG. 11 is a side view of a transverse element being mounted to a vertical element in accordance with the subject invention;

FIG. 12 is a end view of the transverse element;

FIG. 13 is perspective view of a transverse element being mounted to a vertical element in accordance with the subject invention;

FIG. 14 is a fragmentary sectional view of the transverse element;

FIG. 15 is an end view of a slab with a tie rod extending therethrough;

FIG. 16 is a fragmented top view of a slab;

FIG. 17 is a fragmented interior view of a vertical element;

FIG. 18 is a fragmentary side view of a transverse element mounted to a vertical element;

FIG. 19 is a fragmented partially cross-sectional interior view of a vertical element with a pair of transverse elements mounted thereto;

FIG. 20 is a partially cross-sectional top view of a transverse element mounted to a vertical element;

FIG. 21 is a bottom view of another portion of the frame;

FIG. 22 is a side view of the frame portion of FIG. 19;

FIG. 23 is a end view of the frame portion of FIG. 19;

FIG. 24 is a cross-sectional end view of the frame being mounted to a structure;

FIG. 25 is a front view of a position plate;

FIG. 26 is a cross-sectional end view of the frame mounted to a structure;

FIG. 27 is a top view of a butterfly element;

FIG. 28 is a cross-sectional side view of the butterfly element; and

FIG. 29 is a side view of the butterfly element mounted to a structure.

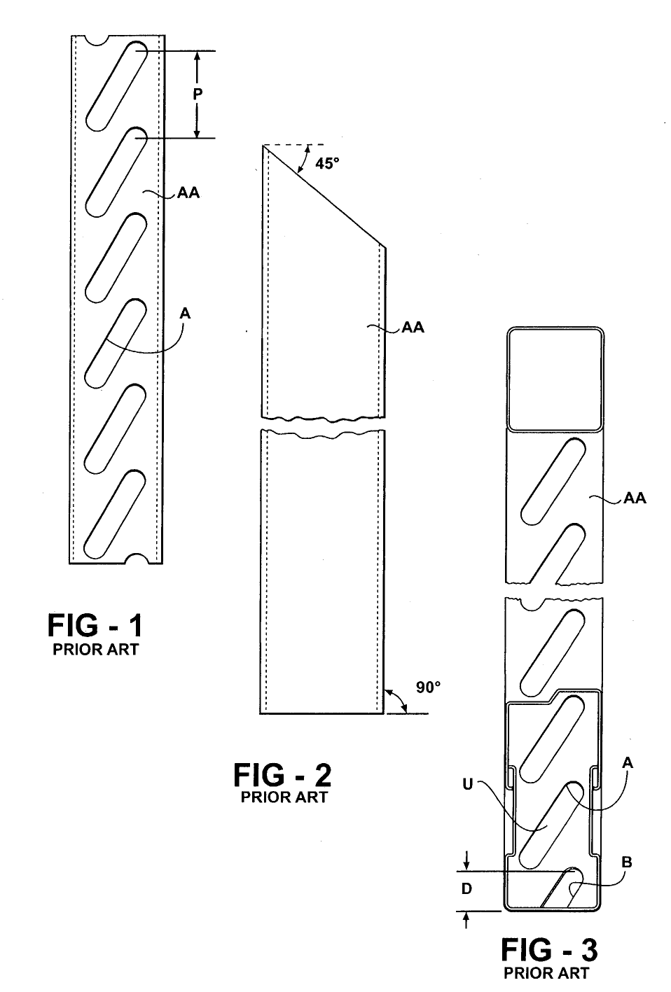

### DETAILED DESCRIPTION OF THE INVENTION

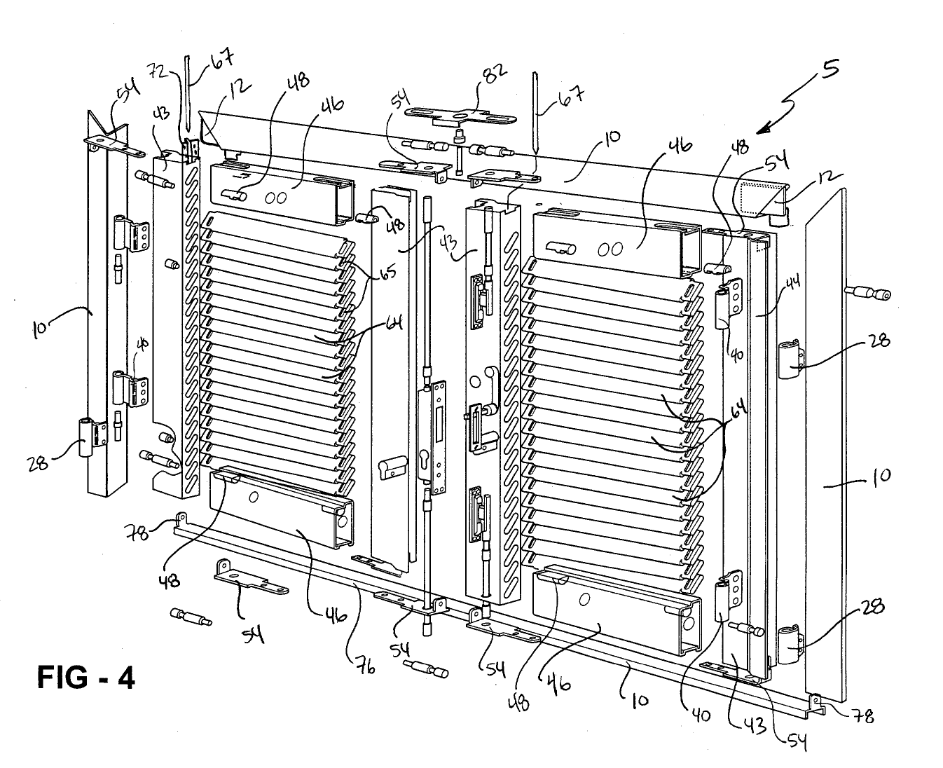

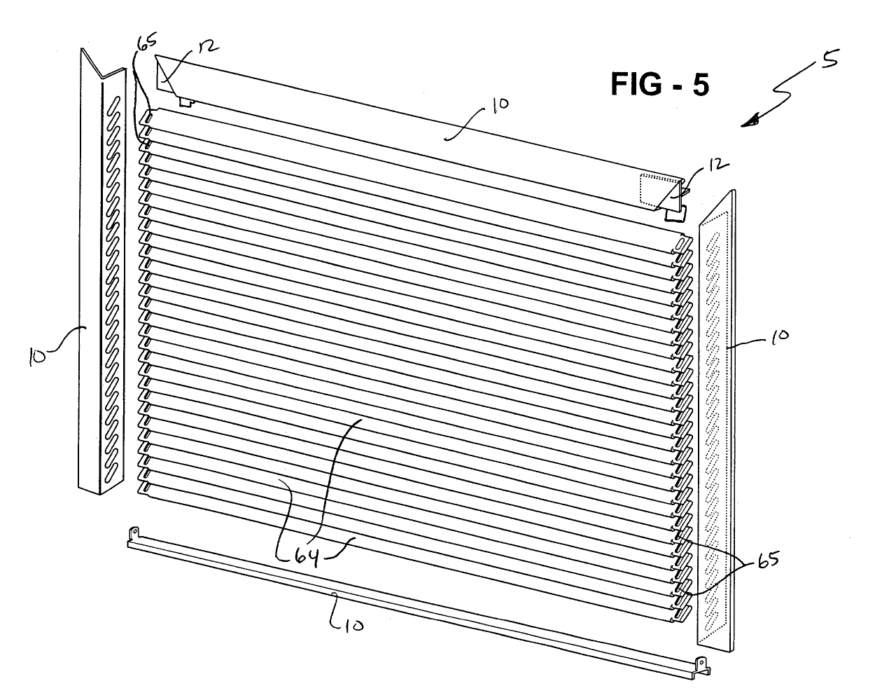

A blind assembly 5 in accordance with the subject invention is generally shown in FIG. 4. The blind assembly 5 shown in FIG. 4 has two wing sections. For illustrative purposes, only one of the wing sections is discussed in greater detail below. FIG. 5 illustrates an alternative embodiment of the blind assembly which is discussed in greater detail below.

The frame system is comprised of a shaped profile, said shape being necessary to justify the use of the fittings, such as hinges, pressure elements, square elements, “bifort supports”, seat protections, deformations (drawings).

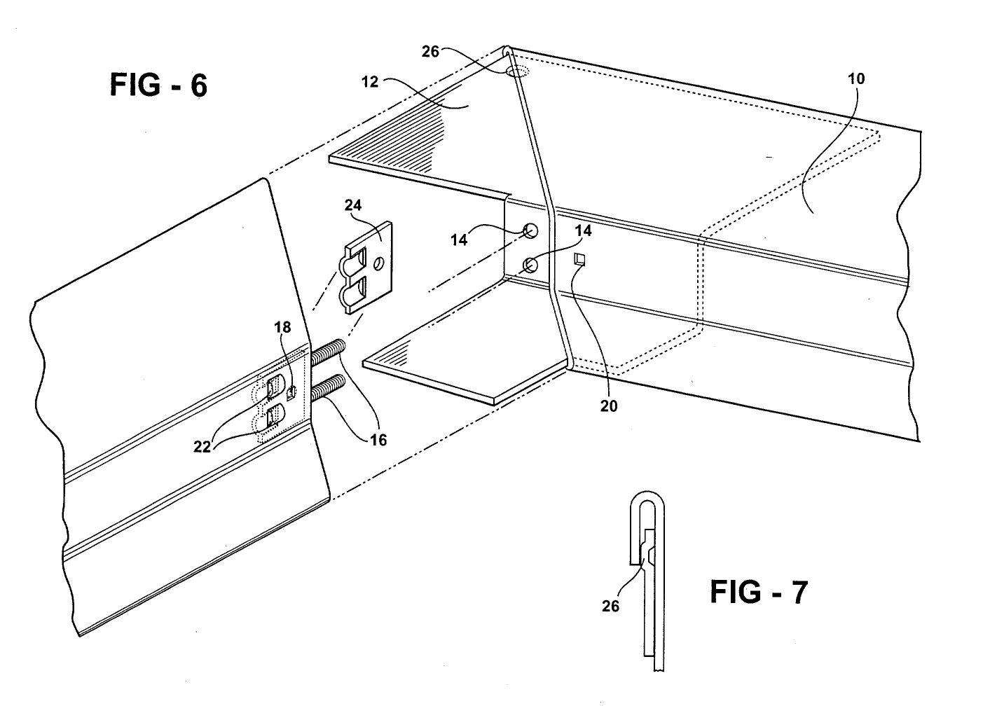

FIG. 6 shows a corner of the profile, with the square element inserted in position.

Profile of the frames 10 of FIG. 6, is cut at 45°, coupled with the particular double tie rod system. In this system, a square element 12 is inserted within the upper transverse portion, into the two ends already cut at 450. FIG. 6 only shows one of them, and how it can be seen. The square element 12 has two round holes 14, that will receive tie rods 16 and a square hole 18 corresponding to a square hole 20 of the frame 10, allowing its integral coupling (transverse square element). Employing a bolt (not shown), having an oval head and a square base, in FIG. 6 it can be seen the position that will receive two tie rods 16; said tie rods 16 will restraint by the bolt head, within rectangular seats 22, to be there kept by a shaped base 24.

The base 24 is tightened by a bolt, as already said, sliding within the square seat of the frames 10 and of the round hole base.

The square element 12 represents a reinforcing element of the cutting corner. As also shown in FIG. 7, it is inserted between the sheet bent parties, in such a way to form a perfect reference restraint plane. Abutment 26 creates a forced point in the profile bent, thus eliminating mechanical clearances.

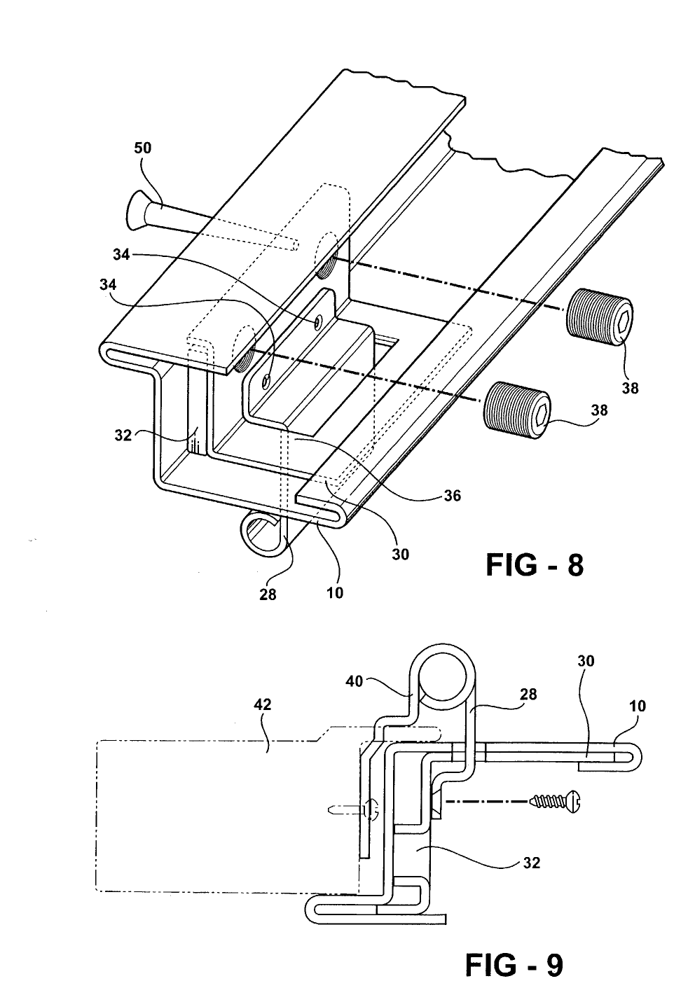

In the frame profile, as seen in FIG. 8, seats are obtained, defining four functions, this representing the optimum solution well realized. Its object is:

1. receiving a hinge 28 of a bearing fixed part;

2. allowing a fixed joint of a support 30, named “bifort”;

3. realizing a box 32 in the coupling, as if the shaped frame 10, that is an opened profile, is twisted in such a way to become box-type, thus stiff;

4. by this seat it is possible to have the relief of the load forces directly from the frame to the counterframe in the wall.

FIG. 8 represents the four function system from inside. It is possible to see both the frame 10 and the support 30 and the hinge 28 overlapped. Locking screws (not shown) are inserted within two holes 34 of the hinge 28, said screws, due to the shape combinations, of the frame 10, the hinge 28, and the support 30, realize the four functions total block assembly without constraining to the frame 10 but only to the support 30. In fact, hinge 28 cannot slide due to tooth 36. Neither the support 30 can slide, since it constraints the hinge 28 and is bucked by the frame 10, that in this way cannot twist. Creating the box 32, pressure elements 38 adjust the installation spaces in the counterframe. The counterpart of the hinge 28 is screwed in the wing posts. FIG. 9 represents the section, summarizing FIG. 8 in combination with the other hinge 40 and the wing where the wing 42 is already hinged with the four functions knot.

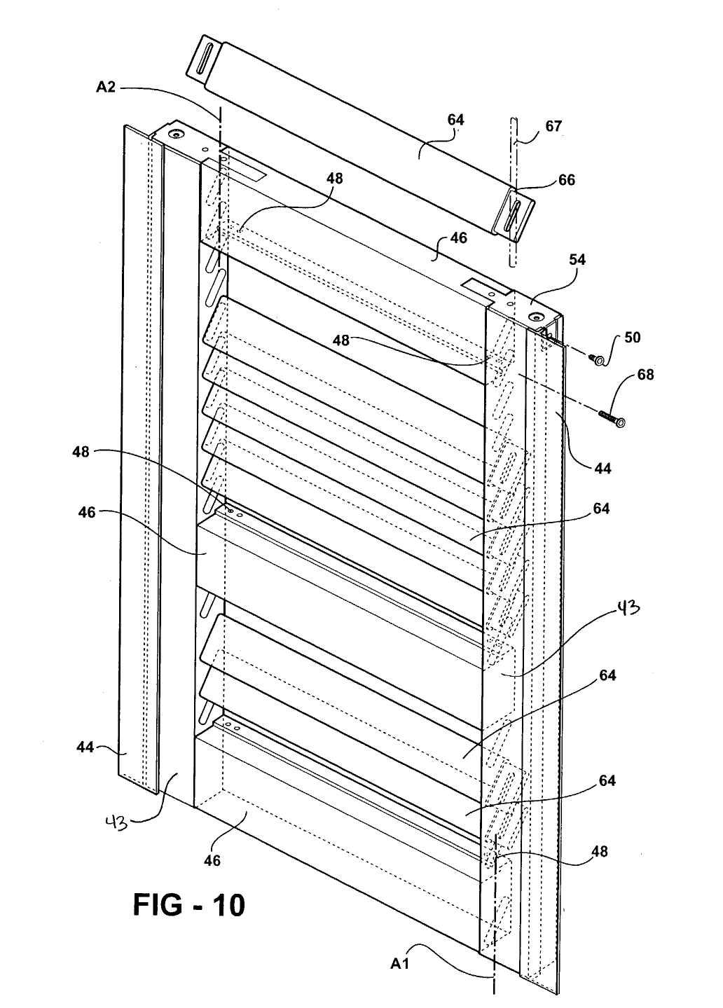

FIG. 4 represents the typical wings in an exploded view and FIG. 10 represents the typical wing already assembled. It is possible to see the slotted vertical elements 43, the characteristic offset lugs 44 of the elements 43 extending in a vertical direction, and not in a horizontal direction. As shown in FIG. 4, a handle and locking mechanism may be incorporated into the vertical elements 43 as is known in the art.

Essential feature is the use of the horizontal transverse elements 46. In the Figure it is possible to note that the use of the traverse elements 46 is the same above and at the bottom, but in the upper part it is assembled upset with respect to the base. The upsetting is essential to be able to cover the assembling screws 50, exploiting the inclination of the slabs. In fact, with the shape of the transverse elements 46, the part that can be seen is the outer side, and the screws 50 are on the inner side.

As shown in the alternative embodiment of FIG. 5, the vertical portions of the frame 10 can have the slots to receive the slabs 64 thereby eliminating the vertical elements 43. The transverse elements 46 can also be eliminated. The removal of the vertical elements 43 and the transverse elements 46 simplifies the design of the blind assembly 5.

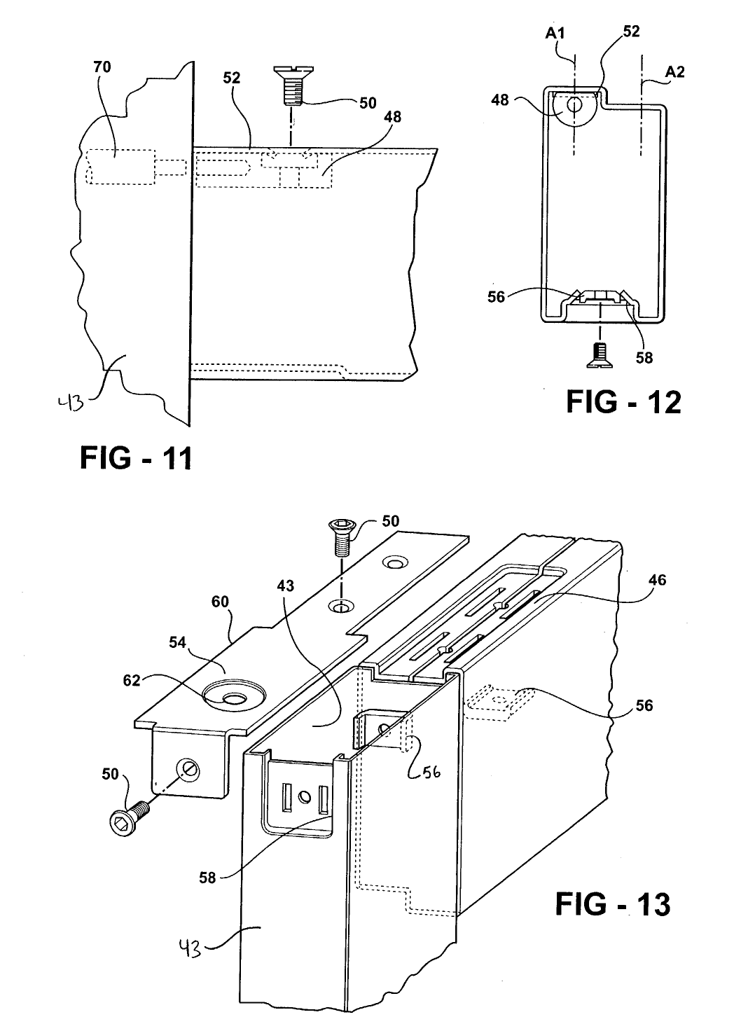

Referring back to the preferred embodiment, mounting blocks 48 are put into evidence in their evidence, but they are described in particular in FIGS. 11 and 12. As it can be noted, mounting blocks 48 with its tooth 52 enters within the thickness of the already breached horizontal element 46, so that, when the screw 50 is tightened, it interlocks the blocks 48 in such a way to be integral in the corresponding opening in the element 46; this allows to relief the torsion force in the opening and not in the screw 50.

It is obvious that the mounting blocks 48 can be applied both in the axis position A1 and in the axis position A2 of FIGS. 10, 11, and 12. In fact, as it can be seen in FIG. 10, in the upper part axis A2 is used, while in the bottom part axis A1 is used, this solution concealing the tightening system from the effraction by ill-intentioned, not allowed to reach them from outside.

In the opposed part of the profile, a partial drawing is created wherein a bracket 54 is housed for the coupling between the vertical slotted elements 43, that are partially drawn, and elements 46.

Characteristic of the elements 46 is that, as it can been seen from the Figures, the profile is not welded. Therefore, it is an open profile that will be blocked and stiffened by the coupling of the bracket 54 and bridge nuts 56, that can be better noted in FIG. 13.

Nuts 56 enter within a seat 58, obtained in the elements 46, said seats 58, beside housing the nuts 56, keep the bridge nuts 56 within the seat 58, since the seat 58 has elastic features allowing their retaining.

The last feature is indispensable since, without the same, it would be impossible the wiring of the brackets 54 with the profiles retaining inside the nuts 56 without the possibility of reaching the same.

The coupling knot has been conceived in this way since all the steel profiles when cut and assembled always have reference quotes and construction tolerances too big.

Thus, each other attempt to assemble them is never equal to the preceding one. Therefore, making the seats 58 that are better described in FIG. 14, said seats 58 house the coupling nuts 58 in all the outer corners of the wing; a seal quote with zero tolerance is determined both for the transverse elements 46 and the vertical slotted elements 43, without taking into consideration the shape, but calibrating the depth of the drawing with the position that will be taken by the bracket 54, to which is entrusted also the prosecution of the ideal alignment of the knot and the oblique part of the seal. In fact, tightening screws, being threaded, do not have the drawback of the tapping screws, that would offset the grip joints, but, on the contrary, since the nuts are realized with sloped planes crimping, it is sufficient to calculate the pulling or the displacement, so that each time the corner is tightened with the bracket 54 and the nuts 56, a perfect mechanical sealing is obtained independently from the constructive defects of the profiles.

In FIG. 14, it is put into evidence the mechanical effect of the bridge nut 56; section has the tightening plane with drawing and sloped planes of the nut 56 with four sides, respectively two inner sides and two outer sides.

Due to the effect of the tightening of the screws, they approach the edges and of the transverse elements 46 (FIGS. 13 and 14), while in the vertical seats they are crimped (FIG. 13).

In this way, transverse elements 46 take the rigidity of the anti-sloping tubular element as an in situ correction. In the mechanical field this effect is really important, mainly for casings, since two wings of the casing, to be closed, require a perfect aligmnent, generally impossible to obtain; reasons for this are due to the not vertical position of the two edges, that never are parallel each other, and to the already mentioned constructive tolerances of the two profiles. But with the open elements 46, it is obtained the correction effect since edges and can slide in such a way to conform to the vertical elements 43 with the contact planes. This operation is allowed by the nut seat 58, then by the tightening of the screws 50, FIG. 13. In FIG. 13, bracket 54 with its bent is shown, said bracket 54 being measure shaped to be fixed close to the drawings obtained both in the transverse element 46 and in the vertical element 43 of FIG. 13. In this way, bracket 54 can maintain a perfect alignment of the same profiles since the wide body 60 of the bracket fixes in the vertical element 43 of FIG. 13. The drawn hole 62 is obtained in the bracket 54 for the passage of the sliding bar (not shown), while three holes collimate with zero tolerance with the nut 56 already fixed in the seats 58. The assembly bracket 54, nuts 56 and seats 58 are thus integral, being very important for the solidity of the corner wing knot.

FIG. 14 put into evidence seats 58 retaining the nut 56 in a tightening position, also without the screw, before being put under pulling conditions.

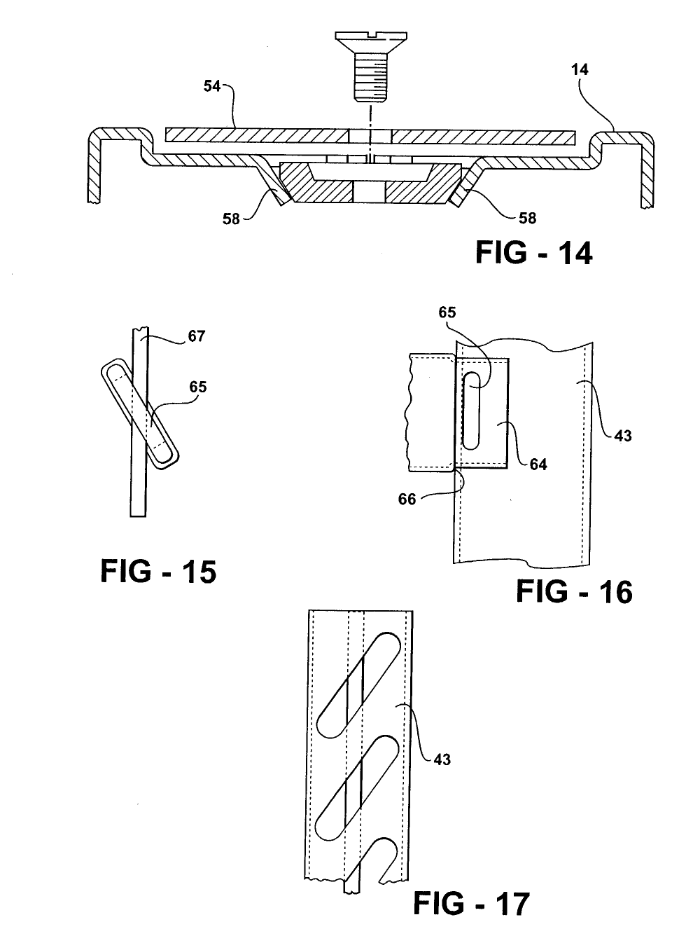

It is well evident that the use of the nuts 56 is consolidated and used also with closed profiles, provided that a perfect execution of the constructive tolerances it ensured, said tolerance being obtained well working in the drawings of the profiles. FIG. 15-17 show the working of the slab 64, i.e. in the oval profile that will be inserted in the slotted element 43. An opening 65 is carried out in the end portion of the width, passing through the two walls of the slab 64. The installed slab 64 has an angle of 270 with respect to a support wall in the vertical element 43; said support wall will be the bucking zone for a square rod 67 inserted therein, passing the oval slab 64.

Square rod 67 can also be a round rod 67, even if the square rod 67 better works for obvious insertion reasons, being provided with a point in the correct direction, while the round rod 67 rotates. However, two systems can be interchangeable. The oval slab 64, once introduced within the vertical slotted element 43 abuts against the wall with a tapered neck 66 and cannot prosecute beyond that point, thus, introducing the square rod 67 into the opening 65, the locking of the square rod 67 and the wall of the slotted vertical tubular element 43 is obtained by bucking.

In FIG. 10, it can be seen the assembly of the oval slabs 64 with the slotted vertical elements 43 that all together create the wing, that is blocked by the insertion of the square or oval rods 67 profiles and using the mounting blocks 48, put under traction by bolt 68 and by the use of the bracket 54 with its nuts 56.

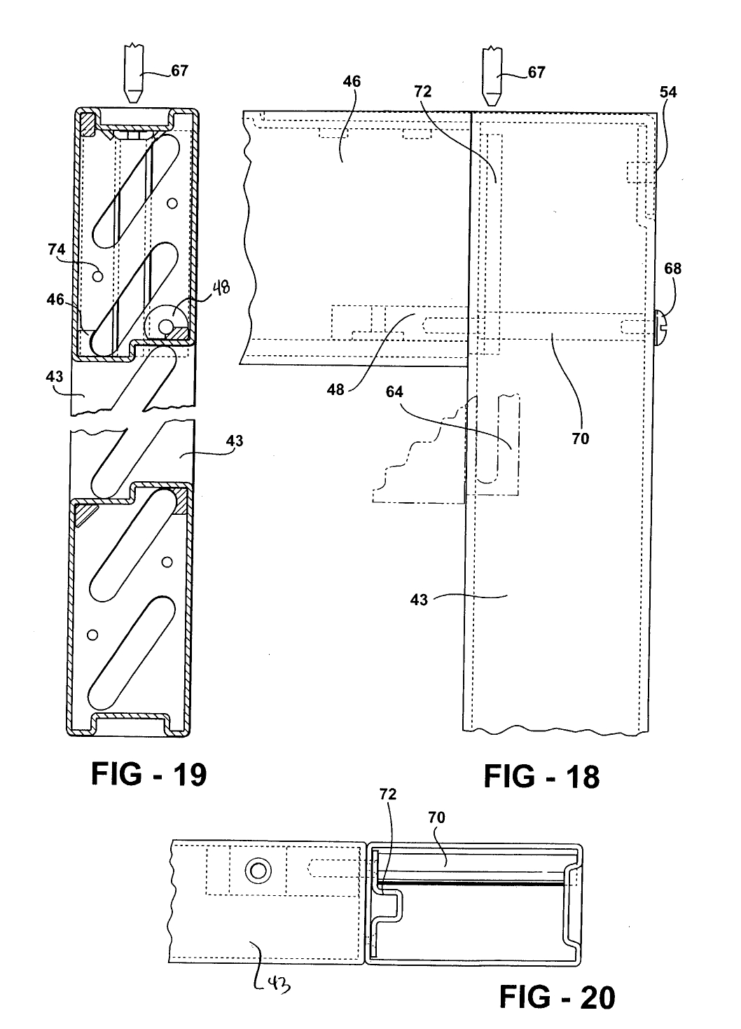

All the above is not in any case sufficient to give an attitude such that all the wing can be said rigid, without any tendency to move some alignment. But since the alignments must not move at all, the system provides that when the transverse elements 46 and the vertical slotted elements 43 meet a particular bucking abutment is realized. In FIGS. 18-20, it is put into evidence the support and meeting plane of the slotted vertical element 43, on that side of the slots of the Figures only some abutments are put into evidence, to better understand the Figure, as it can be seen they are flush realized with respect to the section of the horizontal transverse elements 46 in such a way that in case one pull the tie rod 70 in the mounting blocks 48, the knots blocks without any possibility of translating. Since the buckling abutments creates a out of plane condition on the tie rod 70 side, traction would not be correct; furthermore, slots, creating some empty sections as in the case of the bottom part, where the passage of the tie rod 70 occurs. Therefore, the shaped plate 72 is provided, that is put within the slotted vertical element 43 restoring the resting base of the tie rods. Plate 72 is prefixed in the holes 74, always on the side opposite with respect to the tie rod provided with tearing rivet, in such a way that, when the square rod 67 passing through the slab 64 are in the position, can put the tie rods 70 under pulling condition, with the further object of blocking also the square rods 67, thus all the knot is tightened on a ribbed insert base with round or square rods 67 participating to the solidity and toughness of the joint.

Tie rod 70 is a scaling bolt with a head having the same length of the thickness of the tubular vertical element 43, the object being that of realizing a grip with the transverse elements 46 but maintaining an orthogonal alignment between the tubular vertical element 43 and the base of the measure pre-holed wall. In all cases where the tubular vertical element 43 is very big and it is wished to couple the wall beside the bracket 54 also on the head of the sealing bolt, the bolt 68 is tightened, said bolt 68 having a threading smaller than the coupling hexagon of the tie rod 70 in the wall. The central transverse element 46 has its shape shown in FIG. 10, as it can be seen the difference is the reentering base allowing to the oval slab 64 to completely occupy its seat and to give to the esthetical aspect of the part the same dimension of the bottom part or base.

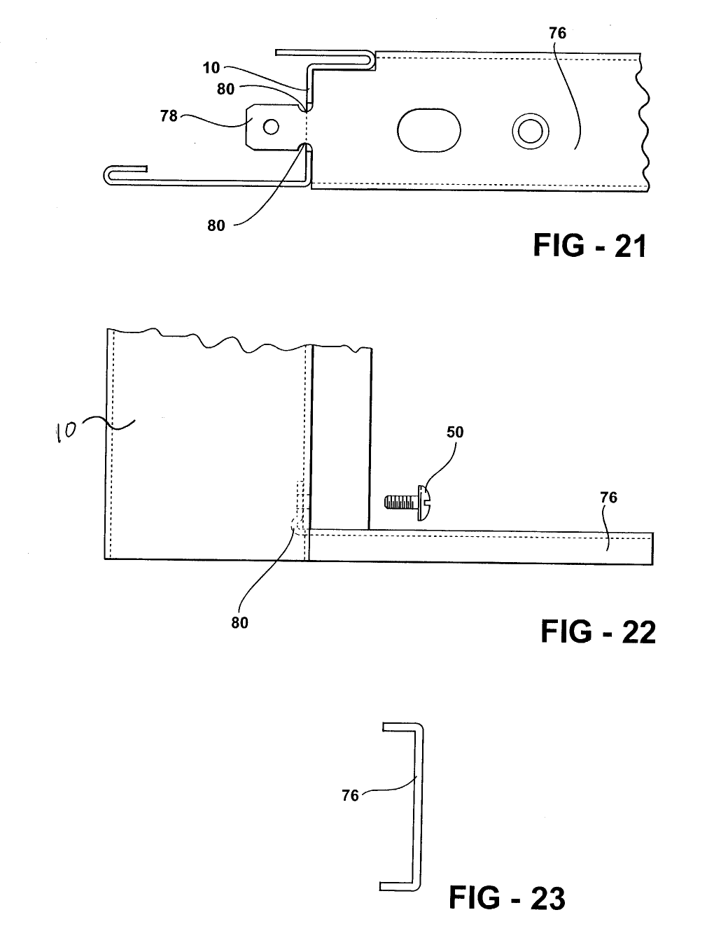

Frame 10 is shown in FIG. 6, it can be closed on all the four corners, but in cases where it is not possible to make it, as in the stamping planes and in some windows, a closure 76 with the transverse element 46 is provided, without square element, but with a U shaped transverse profile, see FIGS. 21-23, as it can be seen from the left side the closure 76 is shaped to obtain a deform able ear 78 with a hole for the fixing of the fixing screw, said ear 78, as it can be seen, passing through the frame 10 within the groove suitably realized and during the blocking it is folded upward, deformation occurring in the relieved point 80, as it can be seen from FIG. 22, detail already folded, tapping screw 50 blocking the whole within the seat. Profile is holed before its use, to receive the key locking sliding bars and the anchoring screw in the stamping plane, as well as water discharges, etc.

As described in the introduction of the presentation of the state of the art, it is mentioned a gap.

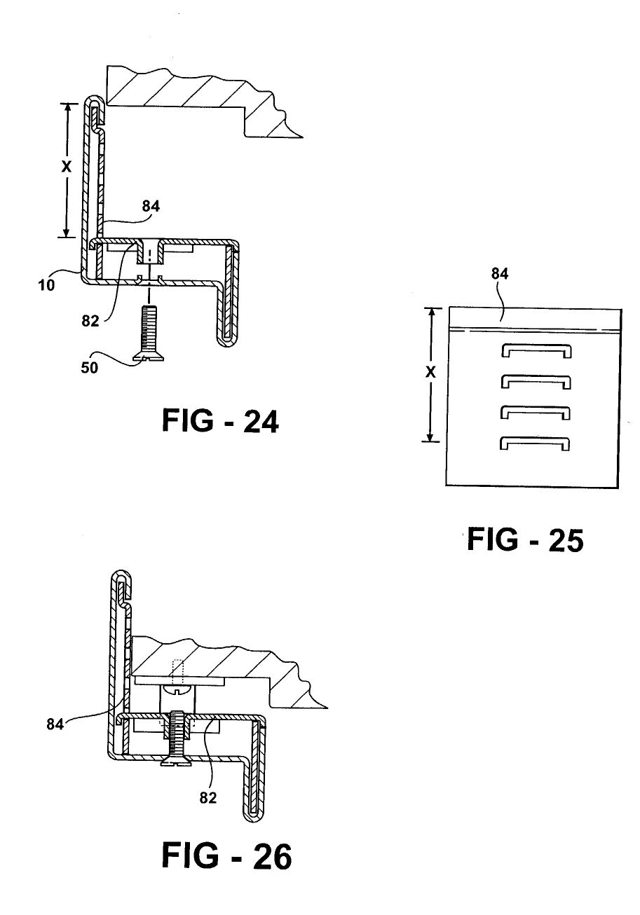

Since “Advanced Siver” system does not provide two C shaped profiles (variable end) since they are not suitable to the total prefabricated, it is necessary to solve in a different way the problem of the various measures referred to the gaps, thus the solution has been individuated transferring the problem of the variable terminal to the frame 10, and precisely, in the following way, see FIG. 24, the upper transverse portion of the frame 10, with a butterfly element 82 and a four position plate 84 are provided. Transverse portion is represented in a descriptive and not limitative way. In FIG. 24, it can be seen the section of the butterfly element 82 installed in the lowest point of the plate element 84, the four positions represent a sum of spaces, representing the slot pitch of the slotted vertical elements 43. The base profile of transverse element 46 is always the same and cannot be modified. In fact if the profile could rise until placing under the slot, if the measure of the slotted element is the same it would be necessary to lower the profile of the element 46 of a length corresponding to the space; but in this way, the upper plane of the transverse element 46 would go in the point and the sectioned slot would be half inside and half outside, and thus it could not be occupied to a whole profile, thus all the measures exceeding a pitch are compensated by the butterfly element 82. Vertical elements 43 are thus cut at 90°, respecting the whole slot, that differs from the cut of few millimeters, always the same, and reducing the bottom of the preceding slot, the same applying for the bottom part of the element 43, in this way we would have posts with fixed pitch slots, always complete slots, both outside the sections occupied by the profiles and within said profiles.

In the Figure it is put into evidence the space that must be recovered at the maximum, to have available another useful slot.

It is obvious that in this way all the possible cut measures of the slots in the elements 43 are limited and always multiple, starting from the minimum measure that will correspond to the space occupied by two transverse elements 46 plus the space of a slot, so that if the transverse elements 46 are 85 and 92 and the slab 42.5, we will have the measure of 85+92+42.5=(219.5), the following measure will be 219.5+42.5=(219.5+42.5)=262. Thus, all the possible measures will be progressively 262+42.5 etc., all the intermediate spaces between a possible measure and the following one will be always lower than the pitch and recovered by the butterfly element 82. In FIGS. 24 and 23, said space is represented in by X, the example with millimeters is only representative, but not limitative, so that the specification is continued in the same way, and it is assumed that X=42.5 minus. Device divides said measure in four spaces, but it is indifferent if more or less spaces are obtained. In the example, four spaces from 1° to 5° place are sufficient. Butterfly element 82 is positioned in place 1°, see FIG. 24, is blocked by screw 50, engaging within its seat, thus creating the grip point, pressure coupling the strap sliding all along the frame 10.

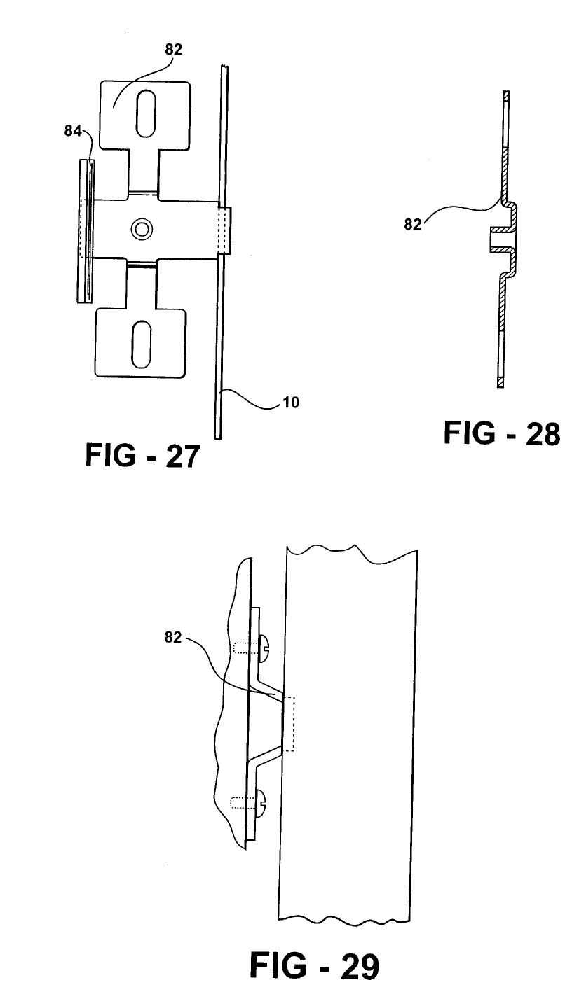

Parallely, at the opposite, butterfly element 82 grasps in the position of the position plate 84 in the lower point 1°; in this way the starting point has been created for the first quarter of the 4/4 of the pitch in case we should recover at most 1/4 of the pitch, in case we should recover 2/4 of the pitch, we would arrive to install the butterfly element 82 within the position plate element 84 in place 2 employing strap (2°), and so on until the last quarter. Therefore, butterfly element 82 can be deformed, see FIG. 26, from a position to the following one in order to fixed to the upper transverse architrave with the screw 50. If we consider FIG. 24, butterfly element 82 can deform until the maximum plane from 1°, sliding, with deformation, all along the space 1°, so that we will have the architrave plane, see FIG. 26, if we observe FIGS. 27 and 28, the portion destined to the deformation can be noted, i.e. two necks of the butterfly element 82 the slots are suitably realized to allow to the butterfly element 82 to slide while screw tightens and pulls upward the deformed base point, making the device suitable to the useful limit space of the 1°¼ of the pitch. FIG. 29 shows the butterfly of FIGS. 27 and 26, already deformed in the 1°¼ in position 2 being fixed in 1°. The device can be fixed in the central point of the transverse frame 10 by screws 50 that are as more longer as more the position of the butterfly is moved upward from 1° to 4° place, thus we will have also four measures of straps, one for each fixing position. All the above device is sufficiently rigid, since the straps are fixed within the folding of the frame, see FIGS. 24 and 26, and position plate 84 in fold 86.

Prefabricated steel blind realized by the “Advanced Siver” system can be a consumer good, with a reduced price in view of the solutions adopted after a careful study, thus the grant of patent for industrial invention is required for its global solution.

What is claimed is:

1. A blind assembly comprising;
a pair of vertical elements each having a top and bottom and a plurality of slots formed therein;
an upper transverse element engaging said tops of said vertical elements;
a lower transverse element engaging said bottoms of said vertical elements;
a plurality of slabs engaging said slots of said vertical elements and extending substantially parallel with said upper and lower transverse elements; and
a mounting arrangement interlocking said upper transverse element to said tops of said vertical elements, said lower transverse element to said bottoms of said vertical elements, and said slabs to said vertical elements for eliminating the need to weld said blind assembly.

2. An assembly as set forth in claim 1 wherein said mounting arrangement is further defined as a bracket interconnecting said upper and lower transverse elements to said vertical elements.

3. An assembly as set forth in claim 2 wherein said mounting arrangement further includes at least one nut engaging a seat on at least one of said vertical and transverse elements with a screw passing through said bracket and said at least one vertical and transverse element to engage said nut which fixedly couples said vertical element to said transverse element.

4. An assembly as set forth in claim 3 wherein said mounting arrangement further includes a plurality of nuts engaging seats on said vertical and transverse elements with screws passing through said bracket and said vertical and transverse elements to engage said nuts which fixedly couples said vertical element to said transverse element.

5. An assembly as set forth in claim 1 wherein said mounting arrangement is further defined as a mounting block secured within each of said upper and lower transverse elements.

6. An assembly as set forth in claim 5 wherein said upper and lower transverse elements each include a tooth with said mounting blocks extending into said teeth to interengage said mounting blocks with said upper and lower transverse elements.

7. An assembly as set forth in claim 5 wherein said mounting arrangement further includes a tie rod extending between each of said mounting blocks of said upper and lower transverse elements and said vertical elements.

8. An assembly as set forth in claim 7 wherein said mounting arrangement further includes a bolt passing through each of said vertical elements and engaging said tie rods for coupling said vertical and transverse elements.

9. An assembly as set forth in claim 1 wherein each of said slabs includes a tapered neck at said distal ends with said neck extending through said slots of said vertical elements.

10. An assembly as set forth in claim 9 wherein each of said tapered necks includes an opening with said openings of said slabs aligning when said slabs are installed within said vertical elements.

11. An assembly as set forth in claim 10 wherein said mounting arrangement is further defined as a rod passing through said aligned openings to fixedly secure said slabs to said vertical elements.

12. An assembly as set forth in claim 1 further including a frame having an upper transverse portion and a pair of vertical portions for substantially surrounding said vertical and transverse elements.

13. An assembly as set forth in claim 12 further including a first hinge section mounted to each of said vertical elements and a second hinge section mounted to said vertical portions of said frame to rotatably mounting said vertical elements to said frame.

14. An assembly as set forth in claim 12 further including an butterfly element and a position plate both mounted to said upper transverse portion of said frame with said butterfly element being positionable along said plate to provide a variable mounting surface for said frame.

15. An assembly as set forth in claim 12 further including a square element disposed within each distal end of said upper transverse portion for engaging said vertical portions to interlock said vertical portions to said transverse portion.

16. An assembly as set forth in claim 15 further including at least one tie rod mounted to one of said upper transverse portion and said vertical portion for engaging a hole within said square element.

17. An assembly as set forth in claim 16 further including a shaped base mounted to said one of said upper transverse portion and said vertical portion for abutting and securing said tie rod to said one of said upper transverse portion and said vertical portion.

18. An assembly as set forth in claim 12 wherein said vertical elements are further defined as said vertical portions of said frame such that said vertical portions of said frame include said slots for receiving said slabs.

19. An assembly as set forth in claim 18 wherein said mounting arrangement is further defined as a square element disposed within each distal end of said upper transverse portion for engaging said vertical portions to interlock said vertical portions to said transverse portion.

20. An assembly as set forth in claim 19 wherein said mounting arrangement further includes at least one tie rod mounted to one of said upper transverse portion and said vertical portion for engaging a hole within said square element.
